(19) United States
(12) Patent Application Publication
(10) Pub. No.: US 2001/0008504 A1
(43) Pub. Date: Jul. 19, 2001

(54) Recording medium playback method and apparatus

(75) Inventors: Akio Tanabe, Saitama-ken (JP); Naoto Arifuku, Saitama-ken (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: PIONEER CORPORATION

(21) Appl. No.: 09/758,373

(22) Filed: Jan. 12, 2001

(30) Foreign Application Priority Data
Jan. 13, 2000 (JP) 2000-4836

(51) Int. Cl. G11B 7/085

(52) U.S. Cl. 369/32

(57) ABSTRACT

Disclosed are a recording medium playback method and apparatus for a recording medium playback system in which recording media of different properties, such as a first recording medium having reproduction information recorded thereon and a second recording medium on which reproduction information and playback control information for controlling a playback order of that reproduction information are recorded, are installed and which plays back the first and second recording media. The recording medium playback method comprises the steps of generating a custom file having at least the first recording medium alone registered therein; and playing back the first and second recording media installed in the recording medium playback system in accordance with registered contents of the custom file. The recording medium playback apparatus comprises a control section for generating a custom file having at least the first recording medium alone registered therein; and a playback section for playing back the first and second recording media installed in the recording medium playback system in accordance with registered contents of the custom file.

### BACKGROUND OF THE INVENTION

1. Field of the Invention

The present invention relates to a recording medium playback method and apparatus which are suitable for use in a disc changer in which optical recording media, such as CD (Compact Disc), VCD (Video Compact Disc) and DVD (Digital Versatile Disc), are installable.

2. Description of the Related Art

Today, people often play CDs, which are popular as recording media for music reproduction, to listen to BGM (Back Ground Music) recorded thereon. CDs are therefore suitable for continuous playback. By way of contrast, people often play VCDs and DVDs to enjoy reproducing and watching recorded videos or music on a display monitor, such as a TV monitor. In this respect, VCDs and DVDs usually have interactive contents that allow each user to select a desirable scene and are therefore often unsuitable for continuous playback.

The VCDs have a capability called PBC (Play Back Control) that reproduces video information and voice information recorded on each VCD in the order intended by a person who has produced the video information and voice information, regardless of the recording order. Therefore, a menu screen which allows a user to select a video to be played and still pictures and moving pictures which provide effective stage effects on recorded video information and voice information are recorded together with the video information, the voice information and PSD (Play Sequence Descriptor) on a video CD which is adapted for the PBC capability.

The DVDs has, as a navigation pack, DSI (Data Search Information) data which is an address for searching for video information or voice information to be reproduced and displayed, and PCI (Presentation Control Information) data which is associated with playback display control that is performed at the time of displaying images or voices detected based on the DSI data. The PCI data includes highlight information that defines the display and operation for each of selectable items, which are activated when a viewer selects their associated item. In accordance with the highlight information, the displayed screen changes for an item selected on an image (menu screen) showing items to be selected by the viewer and the display position to be changed according to the selection and commands or the like for the selected item are set.

A disc changer which is capable of storing plural discs of each of different types, such as the aforementioned CDs, VCDs and DVDs, comes equipped with a so-called custom file capability that preregisters discs, which a user wants to play back, in a custom file and continuously plays back the discs in the file.

Providing a disc changer capable of storing plural recording media, such as CDs, VCDs and DVDs, with the custom file capability, however, significantly reduces the usability of the disc changer because, as mentioned earlier, CDs are suitable for continuous playback while DVDs and VCDs have contents unsuitable for continuous playback. In the case where VCDs or DVDs are stored together with CDs in the disc changer, for example, when the disc changer is set to the continuous playback mode, continuous playback is interrupted by a menu screen or the like. Therefore, some schemes or ideas are needed to register a mixture of discs of different properties in a custom file.

### SUMMARY OF THE INVENTION

Accordingly, it is an object of the present invention to provide a recording medium playback method and apparatus with an improved usability which are for use in a disc changer capable of storing recording media of different properties, and which generate a custom file for each of the properties of the recording media, designate a generated custom file and instruct playback of the recording media registered in the designated file to thereby continuously play back the registered recording media.

To achieve the object, according to one aspect of this invention, there is provided a recording medium playback method for a recording medium playback system in which a first recording medium having reproduction information recorded thereon and a second recording medium on which reproduction information and playback control information for controlling a playback order of that reproduction information are recorded are both installable and which plays back the first and second recording media, which method comprises the steps of generating a custom file having at least the first recording medium alone registered therein; and playing back the first and second recording media installed in the recording medium playback system in accordance with registered contents of the custom file.

According to a first preferable mode of the recording medium playback method, the recording medium playback system determines a type of a recording medium to be stored in the recording medium playback system and generates a management table including type information of the recording medium; and upon reception of an instruction of registering the recording medium as a custom file, the type of the recording medium is determined by referring to the management table and the recording medium is registered in a custom file to be assigned in association with the type.

According to a second preferable mode of the recording medium playback method of the first preferable mode, when a recording medium registering instruction is issued during playback of the recording medium, the type of the recording medium which is being played back is determined by referring to the management table and the recording medium is registered in a custom file to be assigned in association with the type.

According to a third preferable mode of the recording medium playback method of the first preferable mode, a selection menu for custom files where registration is to be made is displayed to prompt a user to select a custom file, a list of those of recording media stored in the recording medium playback system which are registrable is displayed by referring to the management table, and when a recording medium to be registered is selected from the list, the selected recording medium is registered in the selected custom file.

According to a fourth preferable mode of the recording medium playback method of the first preferable mode, the method further comprises the steps of receiving an instruction of designating a custom file and a recording medium to be registered in the custom file; waiting for an input of data about the custom file and the recording medium; checking if the designated recording medium matches with classification of the designated custom file by referring the management table; and registering the designated recording medium in the designated custom file when there is a match.

The usability of a disc changer capable of storing recording media of different properties is improved by generating a custom file for each of the properties of the recording media, designating a generated custom file and instructing playback of the recording media registered in the designated file to thereby continuously play back the registered recording media. When a custom file in which only recording media suitable for continuous playback can be registered is designated and playback of the recording media is designated, particularly, continuous playback will not be interrupted.

There are three ways of registering a custom file. The first way is to register a disc being played directly in a custom file. The second one is to display a list of individual recording media stored in a playback system to prompt a user to make a selection when a registration instruction is issued. The last one is to check if a designated recording medium matches with the classification of a designated custom file and invalidate registration when registration of a first recording medium into the custom file of a second recording medium is instructed.

According to another aspect of this invention, there is provided a recording medium playback apparatus for a recording medium playback system in which a first recording medium having reproduction information recorded thereon and a second recording medium on which reproduction information and playback control information for controlling a playback order of that reproduction information are recorded are both installable and which plays back the first and second recording media, which apparatus comprises control means for generating a custom file having at least the first recording medium alone registered therein; and playback means for playing back the first and second recording media installed in the recording medium playback system in accordance with registered contents of the custom file.

According to a first preferable mode of the recording medium playback apparatus, the control means includes management-table generating means for determining a type of a recording medium to be stored in the recording medium playback system and generating a management table including type information of the recording medium; and custom-file generating means for determining the type of the recording medium by referring to the management table upon reception of an instruction of registering the recording medium as a custom file, and registering the recording medium in a custom file to be assigned in association with the type.

According to a second preferable mode of the recording medium playback apparatus of the first preferable mode, when a recording medium registering instruction is issued during playback of the recording medium, the custom-file generating means determines the type of the recording medium which is being played back by referring to the management table and registers the recording medium in a custom file to be assigned in association with the type.

According to a third preferable mode of the recording medium playback apparatus of the first preferable mode, the apparatus further comprises menu display means for displaying a selection menu for custom files where registration is to be made to thereby prompt a user to select a custom file; and list display means for displaying a list of those of recording media stored in the recording medium playback system which are registrable by referring to the management table, whereby when a recording medium to be registered is selected from the list, the custom-file generating means registers the selected recording medium in the selected custom file.

According to a fourth preferable mode of the recording medium playback apparatus of the first preferable mode, the apparatus further comprises instruction receiving means for receiving an instruction of designating a custom file and a recording medium to be registered in the custom file; input receiving means for waiting for an input of data about the custom file and the recording medium; and means for checking if the designated recording medium matches with classification of the designated custom file by referring the management table, whereby the custom-file generating means registers the designated recording medium in the designated custom file when there is a match.

With the above-described structure, as the control means generates a custom file for each of the properties of the recording media, designates a generated custom file and instructs playback of the recording media registered in the designated file to thereby play back the registered recording media continuously or at random, the usability of a disc changer which can store recording media of different properties and where the invention is adapted is improved.

In the case where discs suitable for continuous playback, such as CDs, and discs unsuitable for continuous playback, such as DVDs and VCDs, are stored in a disc changer, therefore, when the custom file capability that preregisters desirable discs in a custom file and continuously plays back the discs registered in the file is used, a disc unsuitable for continuous playback and a disc suitable for continuous playback will not be registered in a single file. Even when the disc changer is instructed to perform continuous playback, therefore, continuous playback is not be interrupted, thus preventing a user from being irritated by such a break. This leads to an improved usability. When a custom file in which only recording media suitable for continuous playback can be registered is designated and playback of the recording media is designated, in particular, continuous playback will not be interrupted.

### BRIEF DESCRIPTION OF THE DRAWINGS

FIG. 1 is a diagram showing the outer structure of a recording medium playback system to which the present invention is adapted;

FIG. 2 is a flowchart illustrating one example of registering a custom file;

FIG. 3 is a flowchart illustrating another example of registering a custom file;

FIG. 4 is a flowchart illustrating a further example of registering a custom file;

FIG. 5 is a diagram exemplifying the structure of a screen for a direct custom input mode;

FIG. 6 is a diagram exemplifying the structure of a audio custom file;

FIG. 7 is a diagram exemplifying the structure of a video custom file;

FIG. 8 is a diagram exemplifying the structure of a screen for a custom-file selection menu in association with the flowchart shown in FIG. 3;

FIG. 9 is a diagram exemplifying the structure of a screen for a disc selection menu in association with the flowchart shown in FIG. 3;

FIG. 10 is a diagram exemplifying a management table which is generated in a disc auto update process;

FIG. 11 is a diagram showing one example of a screen structure in a custom mode;

FIG. 12 is a flowchart illustrating the outline of the disc auto update process; and

FIG. 13 is a block diagram schematically depicting the internal structure of a disc changer shown in FIG. 1.

### DETAILED DESCRIPTION OF THE PREFERRED EMBODIMENT

A preferred embodiment of the present invention will now be described with reference to the accompanying drawings.

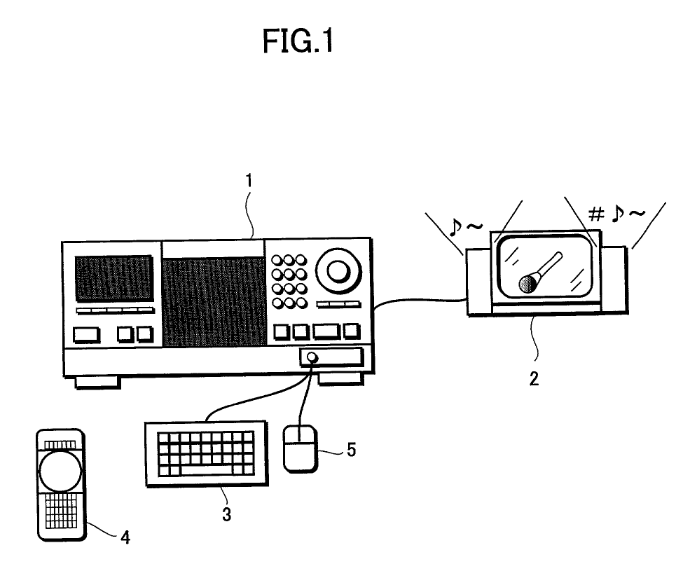

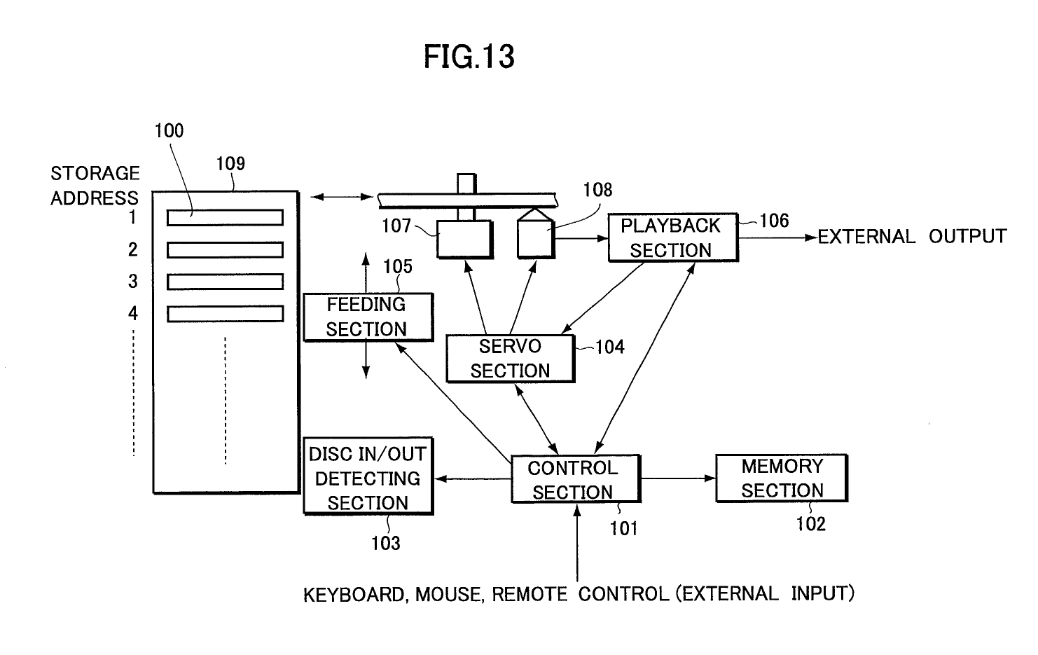

FIG. 1 is a diagram showing the outer structure of a recording medium playback system to which the invention is adapted, and FIG. 13 presents a block diagram depicting the internal structure of a disc changer 1. The disc changer 1 is capable of storing plural discs of different types, such as the aforementioned CDs, VCDs and DVDs. Reference numeral “2” denotes an image and voice monitor, such as a TV with speakers or the like. A keyboard 3 and a remote controller 4 serve to generate an operational instruction to the disc changer 1. Reference numeral “5” denotes a mouse which is used to select individual items on a menu.

In FIG. 13, the disc changer 1 comprises a control section 101 as the control center, a memory section 102, a disc in/out detecting section 103, a servo section 104, a disc feeding section 105, a playback section 106, a spindle motor 107, a pickup 108 and a disc storage section 109. The disc storage section 109 stores a mixture of discs suitable for continuous playback, such as CDs, and discs unsuitable for continuous playback, such as VCDs and DVDs. A program is stored in the memory section 102. The memory section 102 is used as a work area which is used when the program is executed and where, for example, a custom file to be discussed later is registered or various disc information including a management table to be discussed later is set and stored.

The control section 101 controls the individual functional blocks 103, 104, 105 and 106 in accordance with the program stored in the memory section 102. Specifically, the control section 101 detects inputs made through the keyboard 3, remote controller 4, mouse 5 or the like, and fetches information that is acquired through the disc in/out detecting section 103 which is comprised of a sensor. The control section 101 performs optimal control of the servo section 104 to drive the spindle motor 107 and pickup 108. The control section 101 also controls the disc feeding section 105 to load a disc into the disc storage section 109 or unload a disc therefrom. The playback section 106 demodulates a recorded signal which is read by the pickup 108, performs D/A conversion of the recorded signal and sends the resultant digital signal to the image and voice monitor 2 (not shown in FIG. 13).

With the above-described structure, when a user depresses an auto update key (not shown) located on the front panel of the disc changer 1, an auto update operation is carried out to read information of discs stored in the disc changer 1 and register the disc information in the memory section 102.

There are two types of auto updating: additional update that updates only a disc which has been added since the depression of the key and all update that updates all the discs stored in the disc changer 1. In this operation, either the additional update or the all update is selected. In the additional update, disc information is read and the flow proceeds to a mode of inputting a title and the name of an artist for each disc. In the case of a text disc, such as a CD text disc, recorded text information is displayed. In the case of a DVD text disc, there are plural items for an artist, so that a desirable item is selected from the screen. In the case of other types of discs, the user inputs a title and an artist's name using the keyboard 3.

The title and artist's name input this time are stored linked to disc information to be discussed later. Even when a disc storage address in the disc storage section 109 in the disc changer 1 is changed, reading disc information allows a given name to be automatically set. The entry or selection of each name is carried out using the keyboard 3 or the mouse 5.

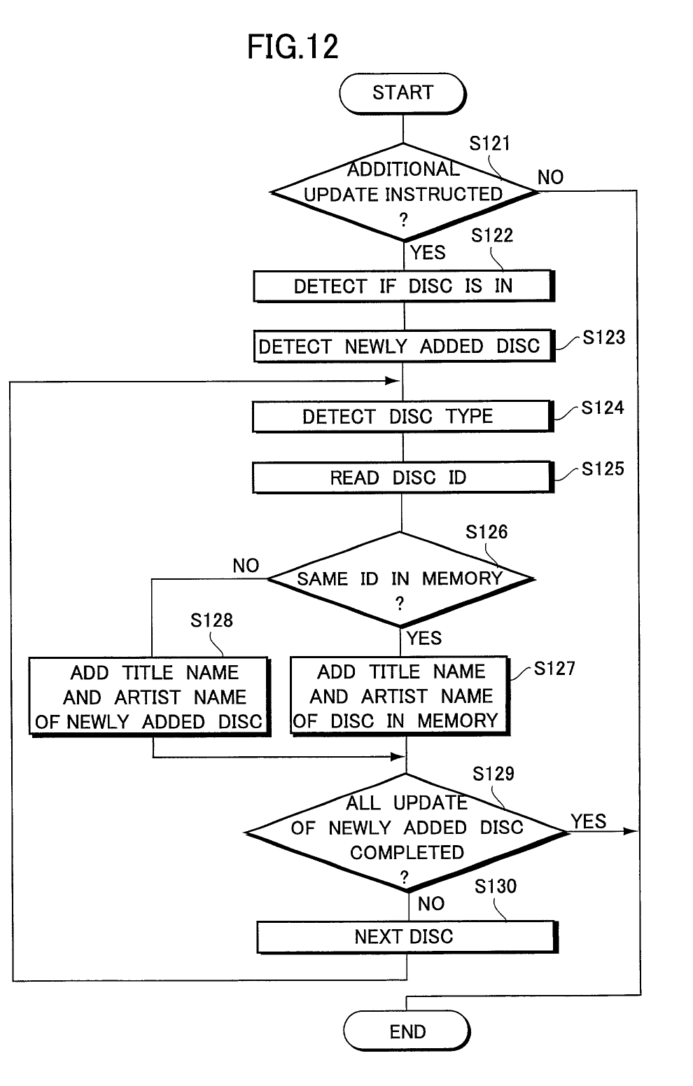

The additional update operation will now be described with reference to a flowchart shown in FIG. 12. This operation is executed by the control section 101 incorporated in the disc changer 1. First, the control section 101 determines whether there is an additional update instruction or not (step S121). When there is the additional update instruction, the control section 101 detects if there are discs in the disc storage section 109 in the disc changer 1 (step S122). When there are no discs, the additional updating is terminated. When there are discs in the disc storage section 109 in the disc changer 1, the control section 101 checks if each disc in the disc storage section 109 is a newly added one (step S123). In this embodiment, for example, disc in/out information of a disc at each storage position in the disc changer 1 has been stored in the memory section 102 beforehand, it is determined in step S122 whether there is a disc or not, and when there is a disc at a new disc storage location which has not been existed before, the disc is recognized as a newly added one.

The control section 101 further determines the type of the disc (step S124). Specifically, the control section 101 determines whether there is a disc or not by detecting the S amplitude of a focus error obtained via the pickup 108. When it is determined that there is a disc, the disc is turned in the mode where a DVD is played (each servo gain, read laser wavelength, etc.) to attempt reading recorded information. When recorded information is read, it is determined that the disc is a DVD, whereas when no recorded information is readable, the disc is turned in the mode of playing a CD. When recorded information is read, it is determined that the disc is a CD. It is further determined whether the disc is a CD or a VCD by reading a subcode. To identify each disc stored in the disc storage section 109 in the disc changer 1, an identification (ID) information specific to each disc is read (step S125). In this example, the first track number (FINO), last track number (LTNO), a lead-out time (LOT), etc. of each disc should be stored as the ID information in the memory section 102 beforehand.

Next, it is determined whether the read ID information has already been registered in the memory section 102. When the ID information is already in the memory section 102, the flow proceeds to step S127, otherwise the flow proceeds to step S128. In step S127, a title and the name of an artist in the memory section 102 are added. In step S128, the title and artist's name are added for each newly added disc. In the case of a CD text disc or DVD text disc, for example, those pieces of information have already been stored on the disc, so that the information may be added or the user may input the information for that disc. In the case of a text disc where plural pieces of artist information are recorded on the single disc, the user may be able to select one piece of the artist information as an artist's name.

The process of the steps S126 and S127 does not erase disc information (disc type, disc title, artist's name, type ID) of one disc updated and registered in the memory section 102 when that disc is unloaded from the disc changer 1, and automatically adds the ID information and disc information of the disc remaining in the memory section 102 even if the same disc is reloaded into the disc changer 1 (the storage location may differ from the previous one) and is actually a newly added disc. Apparently, discs are managed based on, not storage locations, but ID information. It is therefore unnecessary to add the title and artist's name every time an updated disc is changed.

The control section 101 further determines whether all the update of the newly added disc has been completed or not (step S129). When the updating has been completed, the additional update process is terminated. When the updating has not been completed yet, a process for a disc at the next storage location is performed (step S130).

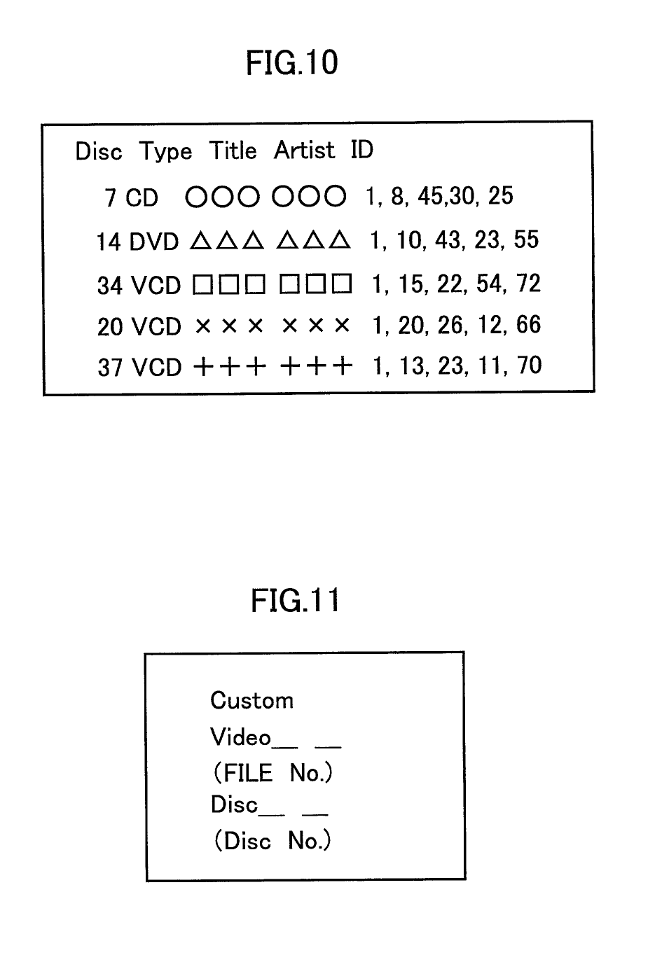

FIG. 10 exemplifies the registered contents of individual discs in the disc changer 1 after updating. In the following description, the registered contents will be called a management table. In the management table, the “Disc” column indicates disc storage positions, the “Type” column indicates disc types, the “Title” column indicates disc names, the “Artist” column indicates the names of artists, and the “ID” column indicates disc ID information (FTNO, LTNO, LOT).

A description will now be given of the custom file capability that is the feature of the invention. It is assumed that a predetermined number of (e.g., ten) custom files can be registered for each of audio and video discs and each file can store a predetermined number of discs (e.g., 300 discs). Each custom file is labeled with characters.

FIGS. 6 and 7 respectively exemplify the structures of an audio custom file and a video custom file. In the figures, the “Type” column indicates the classification of the audio custom file or video custom file, the “No.” column shows file numbers and the “Title” column shows file names.

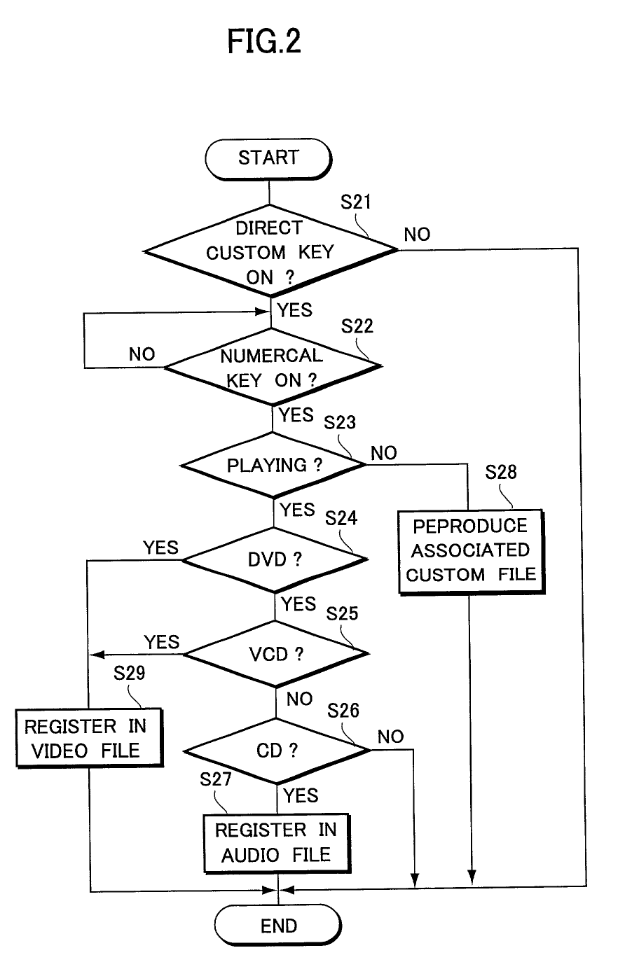

FIGS. 2 through 4 respectively illustrate three ways of registering a custom file in the form of flowcharts. Referring to FIGS. 2-4, disc registration in each custom file will be discussed. In any of the schemes, the control section 101 in the disc changer 1 executes the registration.

(Registration Scheme 1)

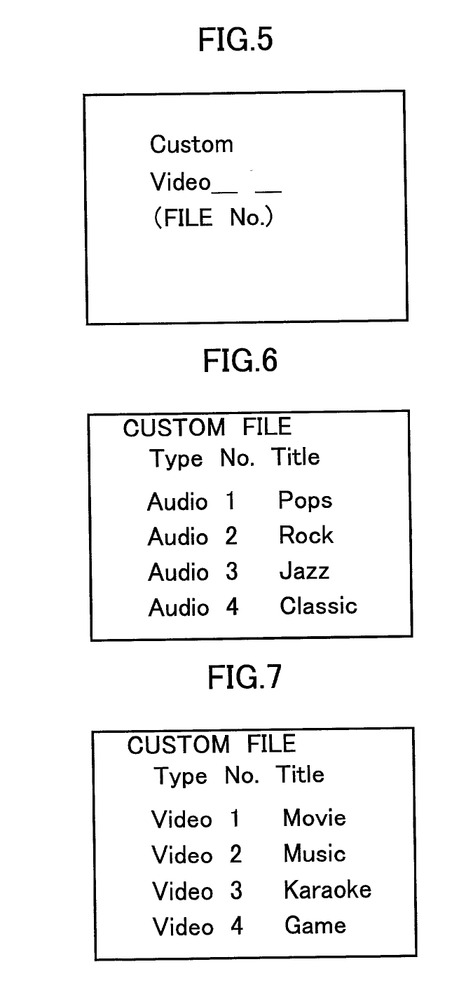

In the flowchart shown in FIG. 2, the control section 101 first determines whether or not a key (direct custom key) for directly registering a disc being played in a custom file has been depressed by manipulating the remote controller 4 or the keyboard 3 or manipulating the mouse 5 on a menu screen (step S21). When the direct custom key has been depressed, a screen display as shown in, for example, FIG. 5 is made to prompt the user to enter a file number. Further, the control section 101 waits for the depression of a numerical key corresponding to the file number of a custom file (step s22). When such a numerical key is depressed, the flow proceeds to step S23.

In step S23, it is determined whether a disc is being played or not. When the disc is being played, the flow proceeds to step S24, otherwise the flow proceeds to step S28. In step S24, it is determined whether the disc being played is a DVD or not. When the disc is a DVD, the flow proceeds to step S29. Otherwise the flow proceeds to step S25. In step S29, the disc that is being played is registered in a video file after which the custom-file registering process is terminated. In step S25, it is determined whether the disc that is being played is a VCD. When the disc is a VCD, the flow proceeds to step S29, otherwise the flow proceeds to step S26.

In step S26, it is determined whether the disc that is being played is a CD. When the disc is a CD, the flow proceeds to step S27, otherwise the custom-file registering process will be terminated.

(Registration Scheme 2)

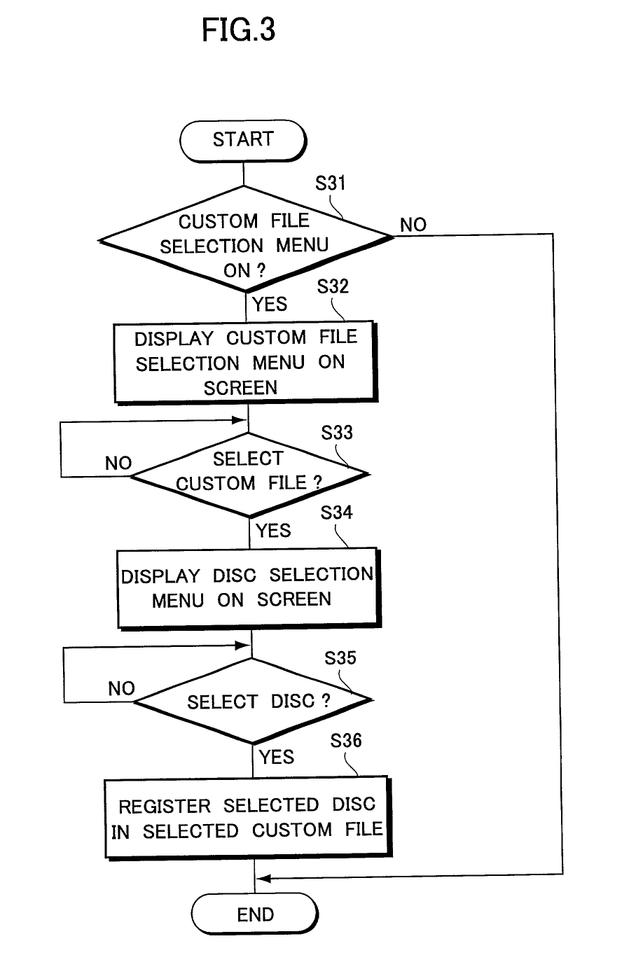

In the flowchart shown in FIG. 3, first, the control section 101 determines whether or not there is an instruction to display a menu (custom-file selection menu) screen for allowing the user to designate and select a custom file where registration is to be made (step S31). When there is the instruction, the custom-file selection menu is displayed (step S32). When the instruction has not been made, the custom-file registering process will be terminated.

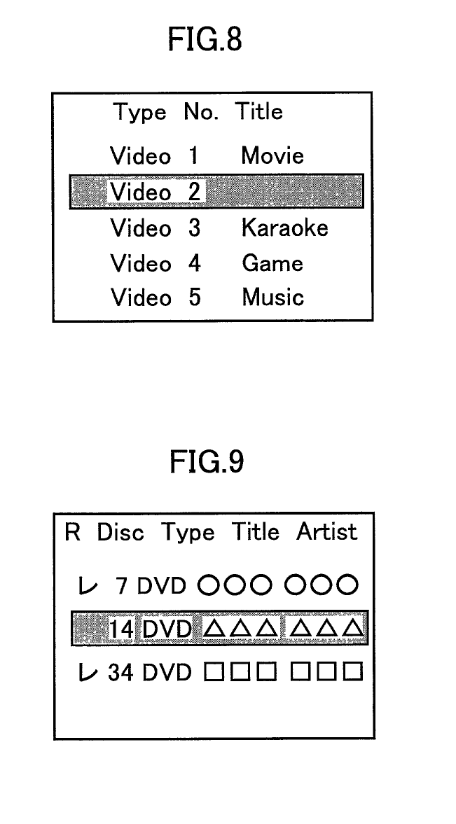

As shown in, for example, FIG. 8, the custom-file selection menu is so designed as to allow a cursor (hatched bar in the diagram) to move to select each custom file using the keyboard 3, the remote controller 4 or the mouse 5. In the diagram, the “Type” column indicates whether a custom file is an audio file or a video file, the “No.” column gives file numbers and the “Title” column gives file names. As the cursor is kept depressed on the menu, video files 1 to 10 and audio files 1 to 10 are scrolled sequentially.

In step S33, the control section 101 waits for the user to select a custom file where registration is to be made using the custom-file selection menu and to set the file by the depression of a set key. When the selected file is set, the flow proceeds to step S34. In step S34, a menu for selecting a disc to be registered is displayed. This menu shows only those discs which are registrable in the selected custom file. When a custom file for which the disc type is “Video” is selected, for example, only those discs which are not suited for continuous playback, such as DVDs and VCDs, are displayed. When a custom file for which the disc type is “Audio” is selected, for example, only those discs which are suited for continuous playback, such as CDs, are displayed. The disc selection menu, as shown in, for example, FIG. 9, is comprised of a list of discs present in the disc changer 1 and a cursor (hatched bar in the diagram) which allows the user to select each disc. The user should move the cursor on the desired disc to be registered.

In step S35, the control section 101 waits for the user to select a disc to be registered in the previous disc selection menu and to set the disc by the depression of the set key. When the selected disc is set, the flow proceeds to step S36. In FIG. 9, the “R” column indicates whether an instruction to fix the registration has been made (registration fixing is instructed by a mark “ [symbol] ”), the “Disc” column shows the storage positions of discs in the disc changer 1, the “Title” column gives file names, and the “Artist” column gives artist names. In step S36, the selected disc is registered in the selected custom file.

(Registration Scheme 3)

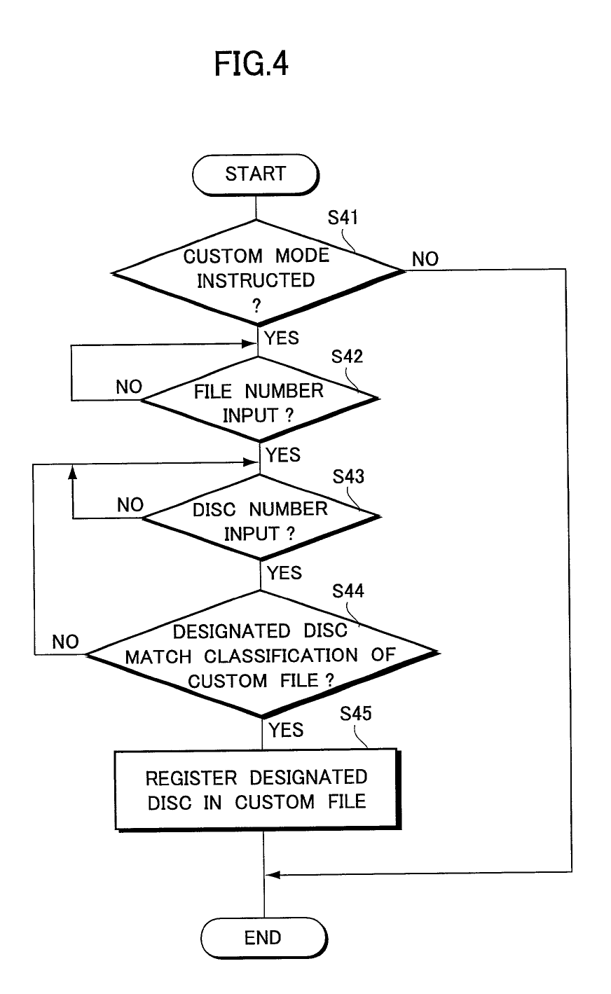

In the flowchart shown in FIG. 4, first, the control section 101 determines whether or not there is an instruction to set a custom mode to directly designate a custom file and a disc (step S41). When there is the instruction, the control section 101 waits for a custom file number to be entered. When the instruction has not been issued, the custom-file registering process will be terminated. In the custom mode, a screen as shown in FIG. 11, for example, is displayed.

The control section 101 first waits for the entry of the number of a custom file where registration is to be made (step S42). When there is such an entry, the flow proceeds to step S43. The control section 101 further waits for the entry of the storage position (disc address) for a disc to be registered (step S43). When there is such an entry, the flow proceeds to step S44. In step S44, the control section 101 determines whether or not the classification (audio or video) of the custom file designated in step S42 matches with the classification (DVD, CD or VCD) of the disc at the disc address designated in step S43. When there is a match, the flow proceeds to step S45. When there is no match, the flow returns to step S43 to wait again for the entry of a disc address. In step S45, the designated disc is registered in the designated custom file.

The custom file where registration has been made is used in such a way as to be reproduced at random between discs registered in the designated file by playing the discs registered n the designated file in the registered order, or designating a custom file and instructing random playback.

Although the foregoing description has been given of the example of registering discs unsuitable for continuous playback, such as VCDs and DVDS, in a video file and registering discs suitable for continuous playback, such as CDs, in an audio file, the invention is not limited to this particular case. Discs which contain information for controlling the playback order may be registered in a video file.

Although the foregoing description has been given of the case where an audio file and video file are both prepared as custom files, only a custom file for registering just discs suitable for continuous playback may be prepared and designated for continuous playback. This modification can also provide the same effect of preventing continuous playback from being interrupted.

As apparent from the foregoing description, the invention improves the usability of a disc changer capable of storing recording media of different properties by generating a custom file for each of the properties of the recording media, designating a generated custom file and instructing playback of the recording media registered in the designated file to thereby play back the registered recording media continuously or at random.

In the case where discs suitable for continuous playback, such as CDs, and discs unsuitable for continuous playback, such as DVDs and VCDs, are stored in a disc changer, therefore, when the custom file capability that preregisters desirable discs in a custom file and continuously plays back the discs registered in the file is used, a disc unsuitable for continuous playback and a disc suitable for continuous playback will not be registered in a single file. Even when the disc changer is instructed to perform continuous playback, therefore, continuous playback is not be interrupted, thus preventing a user from being irritated by such a break. This makes the disc changer 1 easier to use.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A recording medium playback method for a recording medium playback system in which a first recording medium having reproduction information recorded thereon and a second recording medium on which reproduction information and playback control information for controlling a playback order of that reproduction information are recorded are both installable and which plays back said first and second recording media, said method comprising the steps of:
generating a custom file having said first recording medium alone registered therein; and
playing back said first and second recording media installed in said recording medium playback system in accordance with registered contents of said custom file.

2. The recording medium playback method according to claim 1, wherein said recording medium playback system determines a type of a recording medium to be stored in said recording medium playback system and generates a management table including type information of said recording medium; and
upon reception of an instruction of registering said recording medium as said custom file, said type of said recording medium is determined by referring to said management table and said recording medium is registered in said custom file to be assigned in association with said type.

3. The recording medium playback method according to claim 2, wherein when a recording medium registering instruction is issued during playback of said recording medium, said type of said recording medium which is being played back is determined by referring to said management table and said recording medium is registered in said custom file to be assigned in association with said type.

4. The recording medium playback method according to claim 2, wherein a selection menu for custom files where registration is to be made is displayed to prompt a user to select one of said custom files, a list of those of recording media stored in said recording medium playback system which are registrable is displayed by referring to said management table, and when a recording medium to be registered is selected from said list, said selected recording medium is registered in said selected custom file.

5. The recording medium playback method according to claim 2, further comprising the steps of:
receiving an instruction of designating said custom file and said recording medium to be registered in said custom file;
receiving an input of data about said custom file and said recording medium;
checking if said designated recording medium matches with classification of said designated custom file by referring to said management table; and
registering said designated recording medium in said designated custom file when there is a match.

6. A recording medium playback apparatus for a recording medium playback system in which a first recording medium having reproduction information recorded thereon and a second recording medium on which reproduction information and playback control information for controlling a playback order of that reproduction information are recorded are both installable and which plays back said first and second recording media, said apparatus comprising:
control means for generating a custom file having said first recording medium alone registered therein; and
playback means for playing back said first and second recording media installed in said recording medium playback system in accordance with registered contents of said custom file.

7. The recording medium playback apparatus according to claim 6, wherein said control means includes:
management-table generating means for determining a type of a recording medium to be stored in said recording medium playback system and generating a management table including type information of said recording medium; and
custom-file generating means for determining said type of said recording medium by referring to said management table upon reception of an instruction of registering said recording medium as said custom file, and registering said recording medium in said custom file to be assigned in association with said type.

8. The recording medium playback apparatus according to claim 7, wherein when a recording medium registering instruction is issued during playback of said recording medium, said custom-file generating means determines said type of said recording medium which is being played back by referring to said management table and registers said recording medium in said custom file to be assigned in association with said type.

9. The recording medium playback apparatus according to claim 7, further comprising:
menu display means for displaying a selection menu for custom files where registration is to be made to thereby prompt a user to select one of said custom files; and
list display means for displaying a list of those of recording media stored in said recording medium playback system which are registrable by referring to said management table,
whereby when a recording medium to be registered is selected from said list, said custom-file generating means registers said selected recording medium in said selected custom file.

10. The recording medium playback apparatus according to claim 7, further comprising:
instruction receiving means for receiving an instruction of designating said custom file and said recording medium to be registered in said custom file;
input receiving means for receiving an input of data about said custom file and said recording medium; and
means for checking if said designated recording medium matches with classification of said designated custom file by referring to said management table,
whereby said custom-file generating means registers said designated recording medium in said designated custom file when there is a match.
